(19) United States
(12) Patent Application Publication
(10) Pub. No.: US 2015/0363748 A1
(43) Pub. Date: Dec. 17, 2015

(54) METHOD AND APPARATUS FOR TIME-BASED NOTIFICATION DURING AN EVENT

(71) Applicant: HERE Global B.V., Veldhoven (NL)

(72) Inventors: Jerome BEAUREPAIRE, Berlin (DE); Philippe BEAUREPAIRE, Lamballe (FR)

(21) Appl. No.: 14/302,251

(22) Filed: Jun. 11, 2014

(51) Int. Cl. G06Q 10/10

(52) U.S. Cl. CPC G06Q 10/1095

(57) ABSTRACT

An approach is provided for causing, at least in part, a calculation of at least one estimated total time for engaging in at least one event requested by at least one user. The approach involves determining at least one potential time conflict with at least one other event. The approach also involves causing, at least in part, a presentation of at least one notification regarding the at least one potential conflict, the at least one estimated total time, or a combination thereof.

### BACKGROUND

Although it is recognized that users make purchase decisions with incomplete information, we are still unaware about the effect of those missing information on user choices. Uncertainty is always an unavoidable situation when users make their decision based on incomplete information. In the same way, time-based information associated with a product or a service surely influences user's purchasing intentions. For that reason, information on time related consequences pertaining to a product or a service may better assist users in making more informed decisions. However, the existing solution involves manual gathering of time-based information, and then calculating the time-based information. This process is cumbersome and inefficient.

### Some Example Embodiments

Therefore, there is a need for an approach for notifying one or more users on time-based information associated with at least one event.

According to one embodiment, a method comprises causing, at least in part, a calculation of at least one estimated total time for engaging in at least one event requested by at least one user. The method also comprises determining at least one potential time conflict with at least one other event. The method further comprises causing, at least in part, a presentation of at least one notification regarding the at least one potential conflict, the at least one estimated total time, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a calculation of at least one estimated total time for engaging in at least one event requested by at least one user. The apparatus is also caused to determine at least one potential time conflict with at least one other event. The apparatus is further caused to cause, at least in part, a presentation of at least one notification regarding the at least one potential conflict, the at least one estimated total time, or a combination thereof.

According to another embodiment, a computer-readable storage medium carries one or more sequences of one or more instructions which, when executed by one or more processors, cause, at least in part, an apparatus to cause, at least in part, a calculation of at least one estimated total time for engaging in at least one event requested by at least user. The apparatus is also caused to determine at least one potential time conflict with at least one other event. The apparatus is further caused to cause, at least in part, a presentation of at least one notification regarding the at least one potential conflict, the at least one estimated total time, or a combination thereof.

According to another embodiment, an apparatus comprises means for causing, at least in part, a calculation of at least one estimated total time for engaging in at least one event requested by at least user. The apparatus also comprises means for determining at least one potential time conflict with at least one other event. The apparatus further comprises means for causing, at least in part, a presentation of at least one notification regarding the at least one potential conflict, the at least one estimated total time, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system 100 capable of notifying one or more users on time-based information associated with at least one event, according to one embodiment;

FIG. 2 is a diagram of the components of a notification platform 109, according to one embodiment;

FIG. 3 is a diagram of a geographic database 111 of system 100, according to exemplary embodiments;

FIG. 4 is a flowchart of a process 400 for causing an announcement of at least one potential conflict, the at least one estimated total time, or a combination thereof, according to one embodiment;

FIG. 5 is a flowchart of a process 500 for confirming selection of at least one event, determining transport schedule information, determining travel time information, or a combination thereof, according to one embodiment;

FIG. 6 is a flowchart of a process 600 for calculating estimated total time, routing information, predicted pricing trends, or a combination thereof and also involves querying of calendar database, according to one embodiment;

FIGS. 7 A-D represents a scenario wherein users are informed about time-based consequences during purchase of a good or a service by gathering all time related information about upcoming events and actions, according to one example embodiment;

FIGS. 8 A-B are user interface diagrams utilized in the process of initiating a navigation application that allows multiple display of selected routes in a map view and/or an information view, according to one example embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for notifying one or more users on time-based information associated with at least one event are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

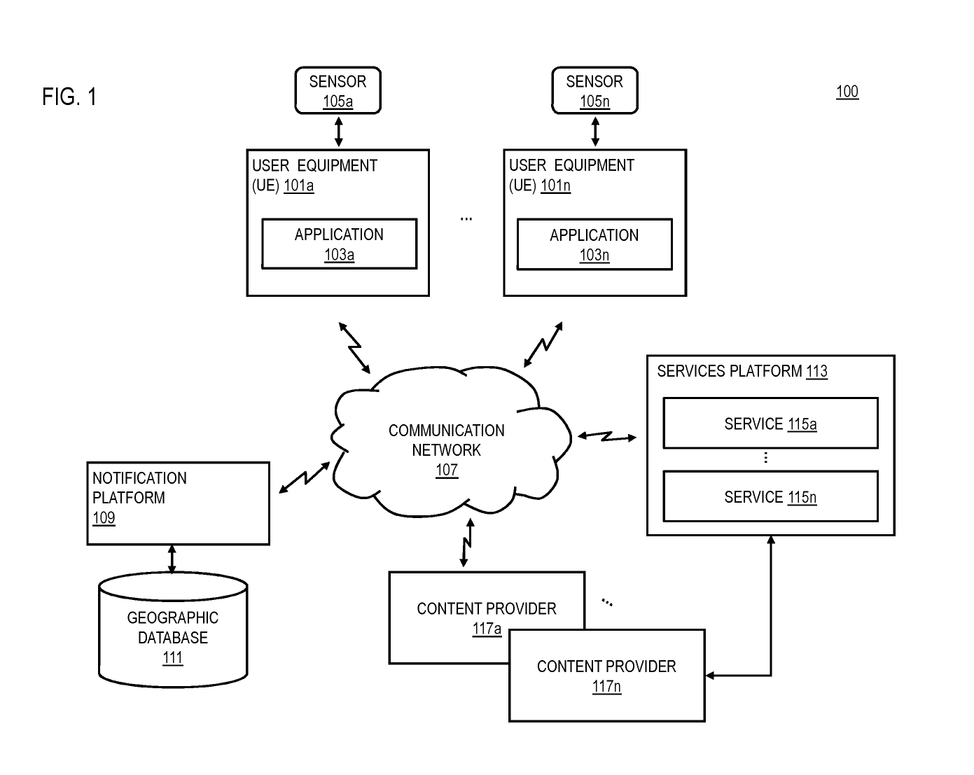

FIG. 1 is a diagram of a system capable of notifying one or more users on time-based information associated with at least one event, according to one embodiment. Missing information is ubiquitous. Often users are faced with decision of what to buy and when to buy without being fully informed. Such incomplete information arguably affects user behavior in different ways. In one scenario, a user purchases a service that he would not have purchased had he known the time-based consequences for that purchase. For example, a user buys a ticket for a concert that conflict with an important meeting with a client. The user cannot attend the concert and would not have bought the ticket had he been informed about his meeting on or before his purchase transaction.

To address this problem, a system 100 of FIG. 1 introduces the capability to compute time-based information associated with an event, and may notify a user before he/she purchases a service. The objective is to make a user completely aware of the temporal consequences of buying a product. The system 100 allows a user to be informed about the consequences of a purchase by gathering all time related information about any upcoming events and actions.

The one or more user equipment 101a-101n (or UE 101) may comprise any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the one or more applications 103a-103n (or applications 103) may be any type of application that is executable at the UE 101, such as location-based service applications, content provisioning services, camera/imaging application, media player applications, social networking applications, navigation applications, mapping application, calendar applications, and the like. In one embodiment, one of the applications 103 at the UE 101 may act as a client for the notification platform 109 and may perform one or more functions associated with the functions of the notification platform 109 by interacting with the notification platform 109 over the communication network 107.

By way of example, the one or more sensors 105a-105n (or sensors 105) may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication (NFC) etc.), temporal information, a camera/imaging sensor for gathering image data, an audio recorder for gathering audio data, and the like. In one scenario, the sensors 105 may include, light sensors, oriental sensors augmented with height sensor and acceleration sensor, tilt sensors, moisture sensors, pressure sensors, audio sensors (e.g., microphone), etc.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the notification platform 109 may be a platform with multiple interconnected components. The notification platform 109 may include multiple servers, intelligent networking devices, computing devices, components and corresponding software for notifying one or more users on time-based information associated with at least one event. In one embodiment, the notification platform 109 may receive at least one request for time-based information associated with at least one event. Then, the notification platform 109 may cause a processing of one or more servers associated with the at least one event to collect time-based information. Subsequently, the notification platform 109 causes, at least in part, a notification of complete time-based information associated with at least one event in at least one device. In one embodiment, the time-based information provided by the notification platform 109 may include starting time for an event, duration of an event, time of arrival to at least one destination, time of departure upon completion of at least on event, schedule of public transportation, a predicted pricing trend for an event, or a combination thereof. In another embodiment, the duration information provided by the notification platform 109 may include any known or anticipated interruptions, estimated completion time for at least one event, or a combination thereof. In one scenario, the notification platform 109 may centralize duration for at least one event, for example, the notification platform 109 may determine check-in information for at least one user to an event for calculating an average duration for the event. The notification platform 109 may cause a presentation of the average duration information to one or more user attending the event.

In one embodiment, the notification platform 109 may cause, at least in part, a comparison of time-based information associated with at least one event with calendar events in at least one device for determining potential conflicts. Then, the notification platform 109 causes, at least in part, a notification in at least one device upon determination of potential conflict. In one scenario, a user may have a calendar event of exercising that may conflict with the event of watching a cinema. The event of buying a cinema ticket for a movie which lasts for 3.5 hours may interfere with user's exercise regimen (e.g. walking/running) and may prevent a user from attaining his/her objective of walking 10,000 steps a day. This information may be presented to the user during his/her purchase transaction because wellness of a user is very important. In such manner, the notification platform 109 may also be associated with the effect of a purchase of a good or a service on daily fitness of a user.

In one embodiment, the notification platform 109 may determine location information for at least one device to cause, at least in part, a presentation of time-based information for at least one segment of routing information, wherein location information is received from device global positioning system identifying latitude and longitude coordinates associated with at least one device. In another embodiment, the notification platform 109 may calculate routing information from at least one point of reference to at least one destination. Then, the notification platform 109 may process and/or facilitate a processing of one or more servers for determining schedules for one or more public transportations. Subsequently, the notification platform 109 determines a predicted travel time for at least one user based, at least in part, on schedules of one or more public transportations, predicted traffic congestion for each of the identified routes, or a combination thereof. The notification platform 109 may present the predicted travel time to the at least one destination to at least one user.

In one embodiment, the notification platform 109 may cause, at least in part, a presentation of one or more segments of routing information in at least one user interface element of a user interface. The notification platform 109 may determine one or more interactions with the at least one user interface element to cause, at least in part, a presentation of one or more other segments of the routing information. In one scenario, the representation of one or more segments of routing information include, at least in part, a map representation, a text-based representation, a multi-media representation, or combination thereof.

In one embodiment, the notification platform 109 may cause, at least in part, a calculation of departure schedule for at least one user to at least one point of reference using preferred mode of transportation based, at least in part, on predicted completion time for an event, total distance to at least one point of reference, schedule of at least one public transportation, or a combination thereof. In another embodiment, the notification platform 109 may also take into consideration parking related scenario during determination of a departure schedule for at least one user. The notification platform 109 may determine closing hours of one or more parking location, and may notify the user during his/her purchase transaction. For example, the notification platform 109 may display a message “purchasing the cinema ticket won't allow you to leave this parking location on time, parking location closes 1 hour before the movie ends, thus options are public transport or taxi”. In a one scenario, an NFC may be used at the point of sale for purchasing tickets to an event. A user may use NFC compatible UE 101 to gain access to an event from anywhere, without waiting in line at kiosk. A user may also interact with smart posters at the concert for information about the band, the current schedule of events, and upcoming performances. The absence of tickets and cards makes the event hassle-free and reduces the chances of being pickpocketed. In short, NFC enables an option for obtaining information to make purchase decisions, as well as, a convenient way to make contactless purchases. In one example embodiment, a vendor may deploy a map with tags representing various locations where events are taking place, a user can touch their UE 101 to the points on the map whereupon the UE 101 may recommend the most efficient event based on the identified destination locations.

In one embodiment, the notification platform 109 may include or have access to the geographic database 111 to access or store any kind of data, for example, routing information, historical user information, location proximity information, temporal information, contextual information, etc. Data stored in the geographic database 111 may, for instance, be provided by the UE 101, the services platform 113, one or more services 115a-115n (or services 115), or one or more content providers 117a-117n (or content providers 117). The information may be any multiple types of information that can provide means for aiding in the content provisioning and sharing process.

The services platform 113 may include any type of service. By way of example, the services platform 113 may include temporal information provisioning services, mapping services, navigation services, travel planning services, location based services, social networking services, content (e.g., audio, video, images, etc.) provisioning services, application services, storage services, contextual information determination services, information (e.g., weather, news, etc.) based services, etc. In one embodiment, the services platform 113 may interact with the UE 101, the notification platform 109 and the content providers 117 to supplement or aid in the processing of the content information to notify one or more users on time-based information associated with at least one event.

By way of example, the services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability.

The content providers 117 may provide content to the UE 101, the notification platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in notifying one or more users on time-based information associated with at least one event. In one embodiment, the content providers 117 may also store content associated with the UE 101, the notification platform 109, and the services 115 of the services platform 113. In another embodiment, the content providers 117 may manage access to a central repository of data, and offer a consistent, standard interface to data.

By way of example, the UE 101, the notification platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

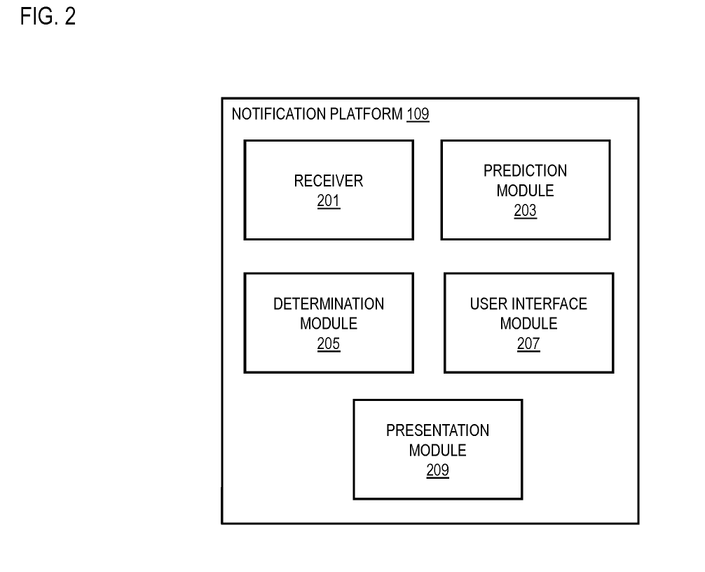

FIG. 2 is a diagram of the components of the notification platform 109, according to one embodiment. By way of example, the notification platform 109 includes one or more components for notifying one or more users on time-based information associated with at least one event. It is contemplated that the functions of these components may be combined in one or more components or performed by other components of equivalent functionality. In this embodiment, the notification platform 109 includes a receiver 201, a prediction module 203, a determination module 205, a user interface module 207, and a presentation module 209.

In one embodiment, the receiver 201 may receive at least one request for time-based information associated with at least one event. In another embodiment, the receiver 201 may receive location information from GPS of a mobile device identifying latitude and longitude coordinates associated with at least one device. In a further embodiment, the receiver 201 may receive time-based information associated with at least one event from the determination module 205. In another embodiment, the receiver 201 may receive calendar information for at least one mobile communication device.

In one embodiment, the prediction module 203 may predict travel time for at least one user based, at least in part, on schedules of one or more public transportations, predicted traffic congestion for each of the identified routes, or a combination thereof. In another embodiment, the prediction module 203 may predict stating time, and completion time for at least one event to determine the total duration of an event. The prediction module 203 may determine any known or anticipated interruptions to determine an estimated completion time for at least one event. In a further embodiment, the prediction module 203 may predict pricing trend for an event.

In one embodiment, the determination module 205 may determine time-based information associated with at least one event. In another embodiment, the determination module 205 may cause comparison of time-based information associated with at least one event with calendar events in at least one device for determining potential conflicts. In a further embodiment, the determination module 205 may determine location information for at least one device to cause, at least in part, a presentation of time-based information for at least one segment of routing information. In another embodiment, the determination module 205 may determine schedules for one or more public transportations to estimate arrival and departure time for at least one event. In another scenario, the determination module 205 may determine user interactions with the at least one user interface element to cause, at least in part, a presentation of one or more other segments of the routing information.

In one embodiment, the user interface module 207 employs various application programming interfaces (APIs) or other function calls corresponding to the applications 103 of the UE 101, thus enabling the display of graphics primitives such as maps, menus, data entry fields, etc., for generating the user interface elements. By way of example, the user interface module 207 generates the interface in response to APIs or other function calls corresponding to the browser application of the UE 101, thus enabling the display of graphics primitives. In another embodiment, the user interface module 207 may cause a presentation of one or more segments of routing information in at least one user interface element of a user interface, wherein the representation of one or more segments of routing information include, at least in part, a map representation, a text-based representation, a multi-media representation, or combination thereof.

In one embodiment, the presentation module 209 obtains a set of summary statistics from other modules, and continues with providing presentation of relevant contents to the at least one device. In another embodiment, the presentation module 209 may cause a presentation of time-based information associated with at least one event in at least one device. In a further embodiment, the presentation module 209 may cause a presentation of time-based information for at least one segment of routing information. In another embodiment, the presentation module 209 may cause a presentation of other available alternative mode of transportation, the determined cost value for alternative mode of transportation, or a combination thereof.

The above presented modules and components of the notification platform 109 can be implemented in hardware, firmware, software, or a combination thereof. Though depicted as a separate entity in FIG. 1, it is contemplated that the notification platform 109 may be implemented for direct operation by respective UE 101. As such, the notification platform 109 may generate direct signal inputs by way of the operating system of the UE 101 for interacting with the applications 103. In another embodiment, one or more of the modules 201-209 may be implemented for operation by respective UEs, as a notification platform 109. Still further, the notification platform 109 may be integrated for direct operation with the services 115, such as in the form of a widget or applet, in accordance with an information and/or subscriber sharing arrangement. The various executions presented herein contemplate any and all arrangements and models.

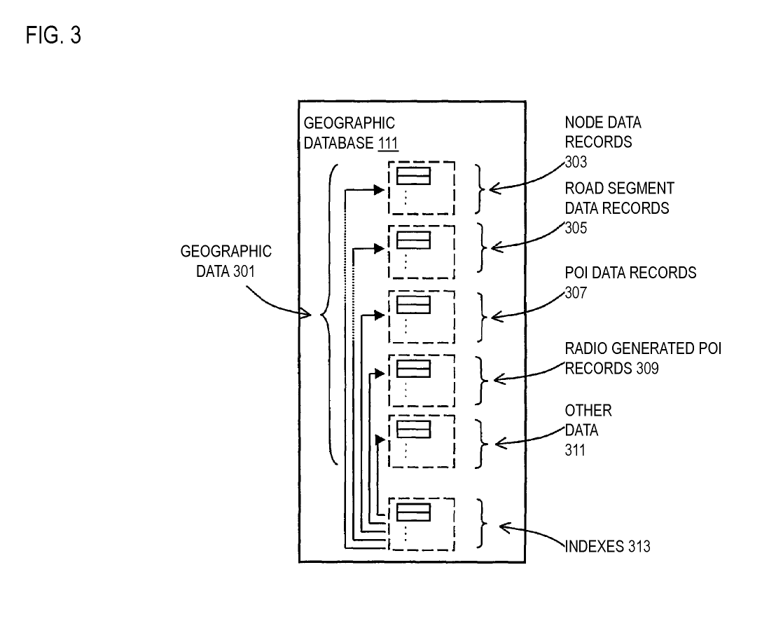

FIG. 3 is a diagram of the geographic database 111 of system 100, according to exemplary embodiments. In the exemplary embodiments, point of interests (POIs) and map generated POIs data can be stored, associated with, and/or linked to the geographic database 111 or data thereof. In one embodiment, the geographic database 111 includes geographic data 301 used for (or configured to be compiled to be used for) mapping and/or navigation-related services, such as for personalized route determination, according to exemplary embodiments. For example, the geographic database 111 includes node data records 303, road segment or link data records 305, POI data records 307, radio generated POI records 309, and other data records 311, for example. More, fewer or different data records can be provided. In one embodiment, the other data records 311 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. In one embodiment, the indexes 313 may improve the speed of data retrieval operations in the geographic database 111. The indexes 313 may be used to quickly locate data without having to search every row in the geographic database 111 every time it is accessed.

In exemplary embodiments, the road segment data records 305 are links or segments representing roads, streets, or paths, as can be used in the calculated route or recorded route information for determination of one or more personalized routes, according to exemplary embodiments. The node data records 303 are end points corresponding to the respective links or segments of the road segment data records 305. The road link data records 305 and the node data records 303 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 307. The geographic database 111 can also include data about places, such as cities, towns, or other communities, and other geographic features, such as bodies of water, mountain ranges, etc. Such place or feature data can be part of the POI data records 307 or can be associated with POIs or POI data records 307 (such as a data point used for displaying or representing a position of a city). In addition, the geographic database 111 can include data from radio advertisements associated with the POI data records 307 and their respective locations in the radio generated POI records 309. By way of example, a street is determined from the user interaction with the UE 101 and the content information associated with the UE 101, according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UE 101) to provided navigation-related functions. For example, the geographic database 111 can be used with the end user device UE 101 to provide an end user with navigation features. In such a case, the geographic database 111 can be downloaded or stored on the end user device UE 101, such as in applications 103, or the end user device UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for determination of one or more personalized routes or route segments based on one or more calculated and recorded routes, according to exemplary embodiments.

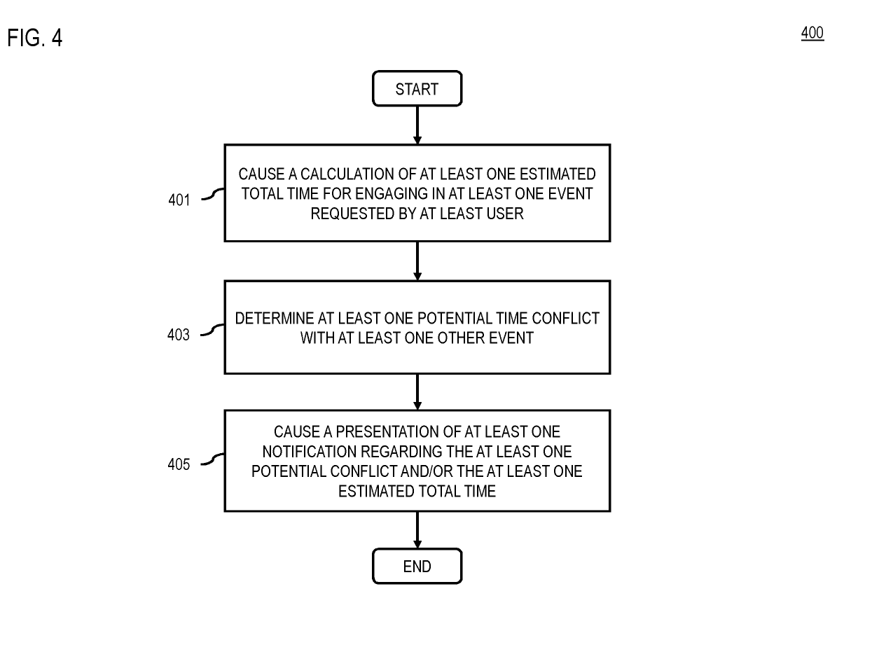

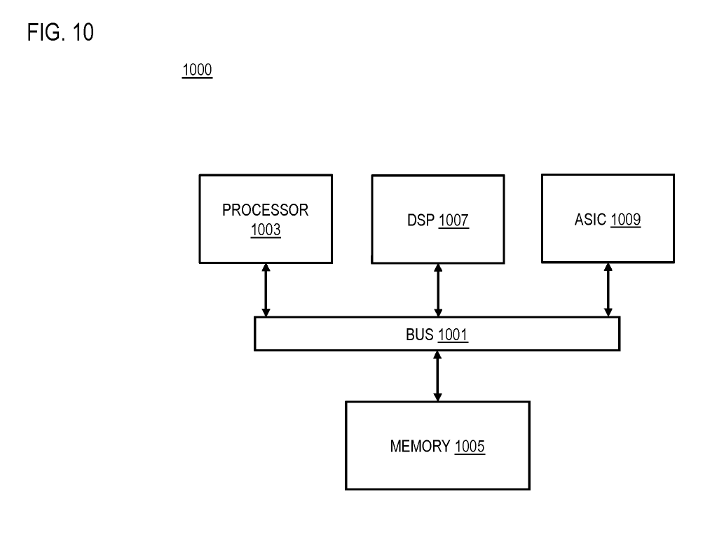

FIG. 4 is a flowchart of a process 400 for causing an announcement of at least one potential conflict, the at least one estimated total time, or a combination thereof, according to one embodiment. In one embodiment, the notification platform 109 performs the process 400 and is implemented in, for instance, a chip set including a processor and a memory as shown in FIG. 10.

In step 401, the notification platform 109 causes, at least in part, a calculation of at least one estimated total time for engaging in at least one event requested by at least user. In one embodiment, the calculation of the at least one total time is based, at least in part, on travel time information associated with traveling to the at least one event, pre-event activity time information, post-event activity time information, intermission time information, interruption time associated, or a combination thereof. In one scenario, pre-event activity time information includes information on new movie trailers and advertisement before the movie actually starts. In another scenario, post-event activity time information includes time needed to pack up and leave, time to go to the restroom, time for cleaning up before leaving, etc.

In step 403, the notification platform 109 determines at least one potential time conflict with at least one other event. In one scenario, the notification platform 109 may cause a comparison of time-based information of at least one event with the calendar information in at least one device to determine any potential conflicts. In another scenario, the notification platform 109 may cause a comparison of time-based information of at least one event with time-based information gathered from one or more backend servers associated with the at least one event to determine potential conflict.

In step 405, the notification platform 109 causes, at least in part, a presentation of at least one notification regarding the at least one potential conflict, the at least one estimated total time, or a combination thereof. In one scenario, the notification platform 109 may determine that the timing of a movie screening conflicts with an urgent meeting, whereupon a user may be notified about the conflict before he purchases the movie ticket. In another scenario, the notification platform 109 may determine that the completion time for an event conflicts with the schedule of a public transportation. The notification platform 109 may warn the user about the unavailability of any public transportation after the event is complete. Further, the notification platform 109 may recommend a user to attend the event at a different time or may suggest an alternative mode of transportation after the event. In one scenario, the at least one estimated total time may be based, at least in part, on any known or anticipated interruptions, travel information, or a combination thereof. In another scenario, the notification platform 109 may take into consideration the queuing time before and/or after an event while calculating an estimated total time for an event. The notification platform 109 may cause a presentation of the queuing information with the average duration based on contextual information.

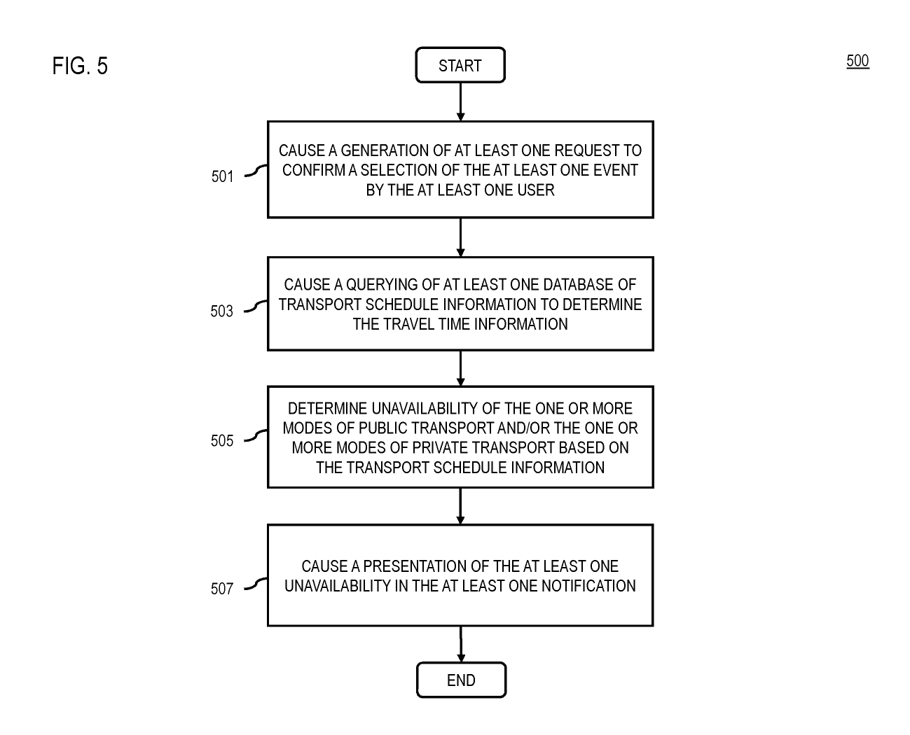

FIG. 5 is a flowchart of a process 500 for confirming selection of at least one event, determining transport schedule information, determining travel time information, or a combination thereof, according to one embodiment. In one embodiment, the notification platform 109 performs the process 500 and is implemented in, for instance, a chip set including a processor and a memory as shown in FIG. 10.

In step 501, the notification platform 109 causes, at least in part, a generation of at least one request to confirm a selection of the at least one event by the at least one user, wherein the at least one request to confirm is included in the at least one notification. In one scenario, the notification platform 109 may cause a presentation of time-based information in a UE 101 before a user makes a purchase for an event. Further, the presentation includes an option to proceed with the purchase transaction, wherein a user may press the ‘confirm purchase’ user interface element to select an event.

In step 503, the notification platform 109 causes, at least in part, a querying of at least one database of transport schedule information to determine the travel time information, wherein the transport schedule information relates, at least in part, to one or more modes of public transport, one or more modes of private transport, or a combination thereof. In one scenario, the notification platform 109 may process servers associated with one or more transportations to determine their schedules. Then, the notification platform 109 may correlate the transportation schedules with at least one event to determine potential conflicts. Further, the determination of schedules for transportations may assist the notification platform 109 in recommending alternative modes of transportation.

In step 505, the notification platform 109 determines at least one unavailability of the one or more modes of public transport, the one or more modes of private transport, or a combination thereof based, at least in part, on the transport schedule information. In one scenario, the notification platform 109 may determine that public transportation is not available after an event is over, at which point the notification platform 109 may recommend available substitute transportation (e.g. taxi). In addition, the notification platform 109 may provide a user with information on the cost of riding the available substitute transportation (e.g. taxi). In one scenario, the notification platform 109 may provide at least one user with a complete related cost for an event. The notification platform 109 may provide valuable hints a user, and may guide a user in making different choices, for example, a user may be suggested to attend a different event which may cost more but finishes earlier, and the user does not require a taxi ride afterwards.

In step 507, the notification platform 109 causes, at least in part, a presentation of the at least one unavailability in the at least one notification. In one scenario, the notification platform 109 may cause a presentation in at least one UE 101 informing a user on inaccessibility of at least one mode of transportation. Then, a user may decide to purchase tickets for an event based, at least in part, on the availability of transportation services after an event is complete.

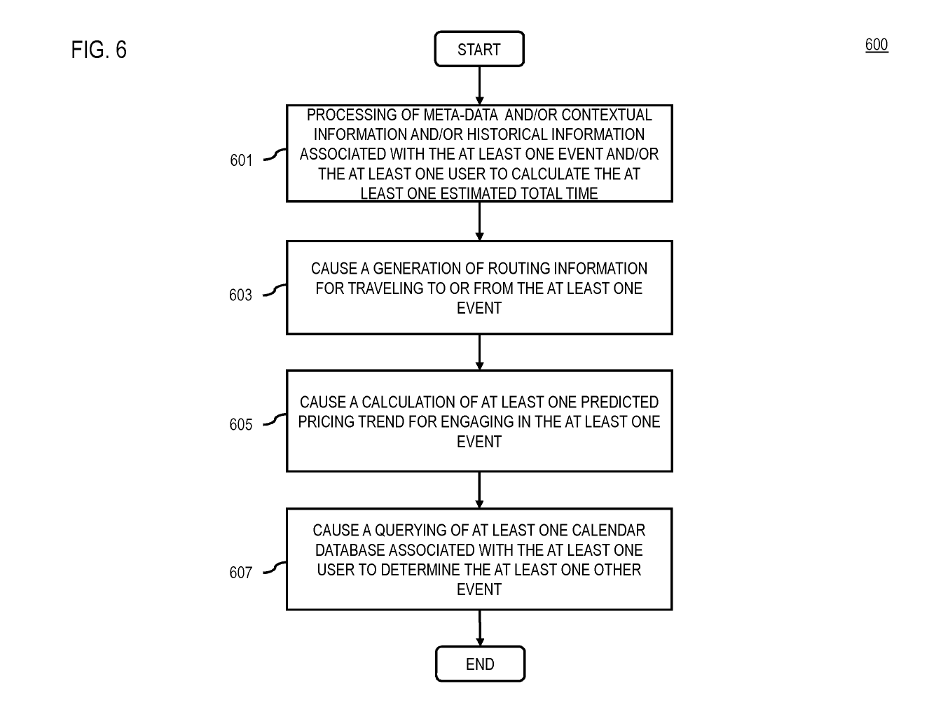

FIG. 6 is a flowchart of a process 600 for calculating estimated total time, routing information, predicted pricing trends, or a combination thereof, and also involves querying of calendar database, according to one embodiment. In one embodiment, the notification platform 109 performs the process 600 and is implemented in, for instance, a chip set including a processor and a memory as shown in FIG. 10.

In step 601, the notification platform 109 processes and/or facilitates a processing of meta-data, contextual information, historical information, or a combination thereof associated with the at least one event, the at least one user, or combination thereof to calculate the at least one estimated total time. In one scenario, contextual information includes location information for at least on user via one or more sensors 105. In one scenario, the notification platform 109 may process historical information associated with at least one event to determine possible interruptions that might affect the completion time for an event. In another scenario, the notification platform 109 may process the meta-data associated with at least one event to determine any additional information that might assist in calculating the estimated total time.

In step 603, the notification platform 109 causes, at least in part, a generation of routing information for traveling to or from the at least one event, wherein the total estimated total time is further based, at least in part, on the routing information. In one scenario, the notification platform 109 may calculate the routing information for at least one user based, at least in part, on location information, historical information (e.g. travel patterns), or a combination thereof. In one example embodiment, the notification platform 109 may select routes and/or modes of transportation associated with the selected destination based, at least in part, on the proximity information. In another scenario, the notification platform 109 may take into account the risk of traffic congestion during travel to at least one destination. For example, the notification platform 109 may determine traffic congestion during the time a user is to pass through, if traffic congestion is detected an alternative route is selected. The notification platform 109 may amend the routing information to ensure minimal traffic congestion.

In step 605, the notification platform 109 causes, at least in part, a calculation of at least one predicted pricing trend for engaging in the at least one event, wherein the at least one notification further includes, at least in part, the at least one predicting pricing trend. In one embodiment, the at least one notification includes, at least in part, one or more alerts indicating that the at least on pricing trend is increasing or decreasing. In one example embodiment, a user may decide not to purchase a ticket for an event due to time-based consequences. Then, the notification platform 109 may inform a user that the ticket price may increase as per the pricing trends unless purchased within a certain time period.

In step 607, the notification platform 109 causes, at least in part, a querying of at least one calendar database associated with the at least one user to determine the at least one other event. In one scenario, the notification platform 109 may process the calendar information associated with at least one user to determine scheduled events for at least one user. Then, the notification platform 109 may recommend other events to at least one user around the calendar events. In such manner, the notification platform 109 causes a harmonious incorporation of one or more events for at least one user.

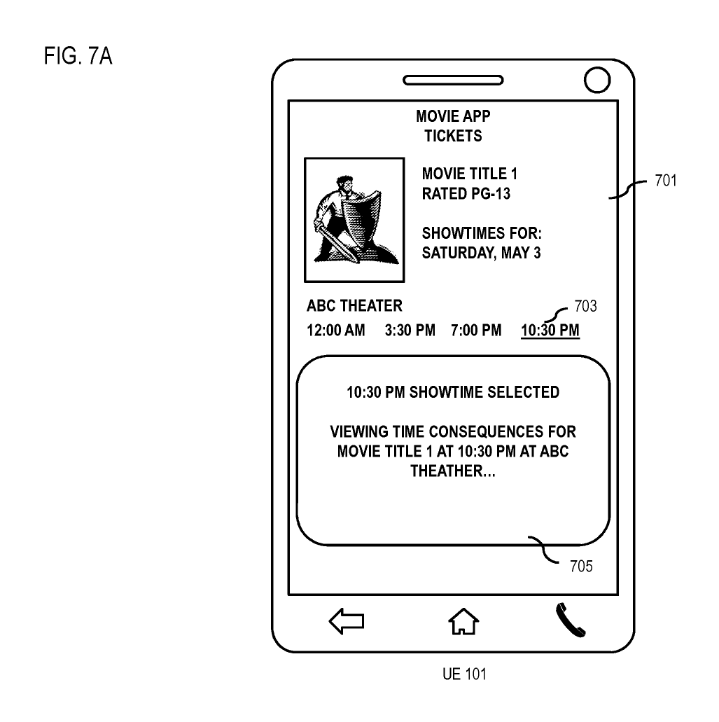

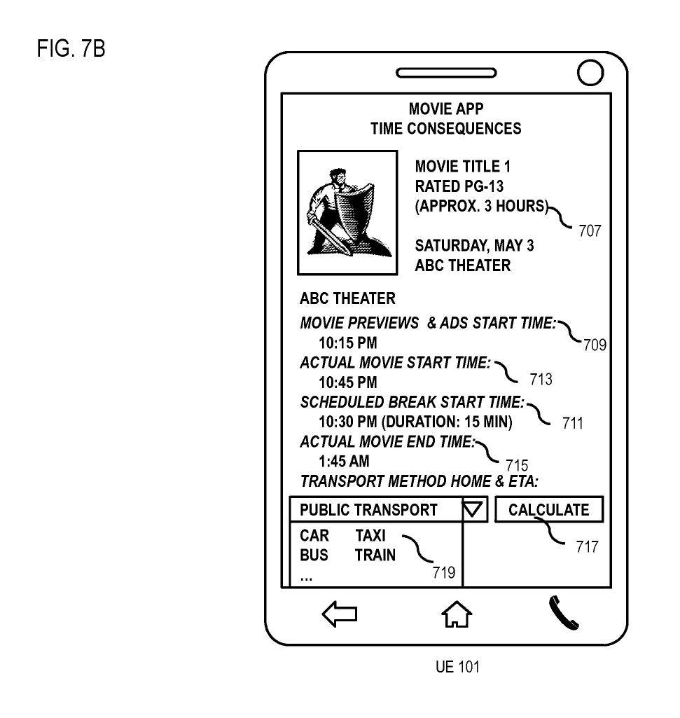

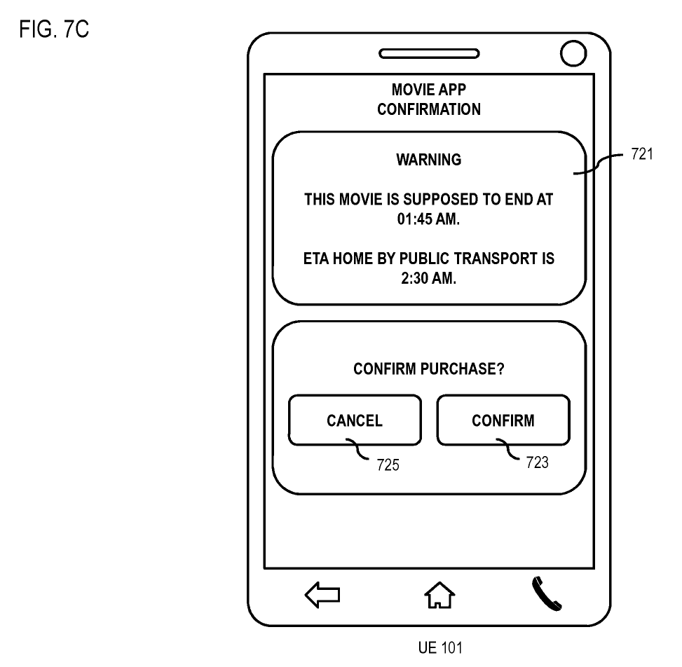

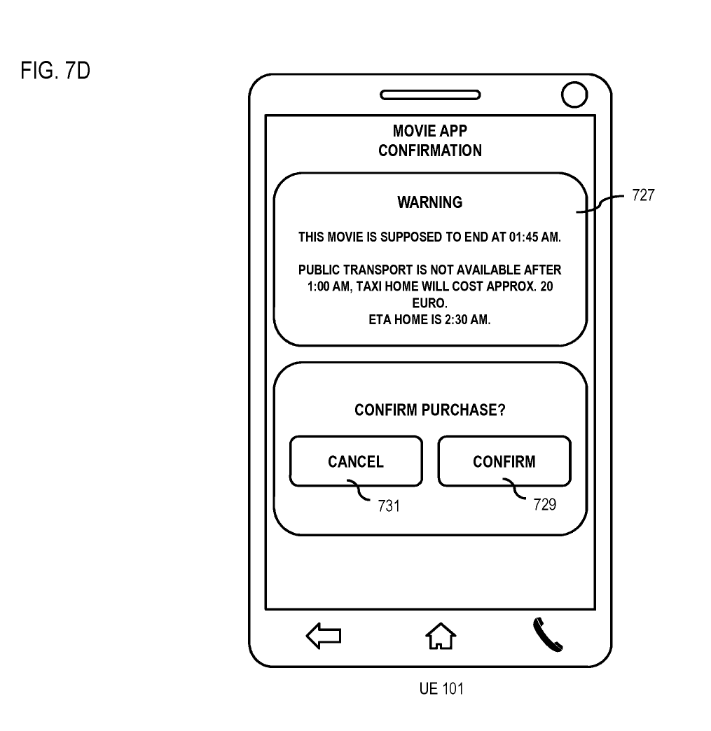

In one scenario, a user may go to the cinema for a movie that is supposed to start at 10:00 p.m. However, the movie starts after 45 minutes of new movies trailers and advertisements. Further, at 11:45 p.m. the lights are switched-on and the user realizes that there is a 15 minutes break as the movie lasts for 3 hours. In order to avoid such circumstances, FIGS. 7 A-D represents a scenario wherein users are informed about time-based consequences during purchase of a good or a service by gathering all time related information about upcoming events and actions, according to one example embodiment. FIG. 7 A represents a scenario in which a user decides to purchase a movie ticket via his/her UE 101 [701]. The user may choose the 10:30 p.m. screening [703], whereupon the notification platform 109 may receive a request for time-based information associated with the purchase of the movie ticket. The notification platform 109 may cause a processing of the one or more servers associated with the event of purchasing the ticket for a particular movie at a particular time. Then, the notification platform 109 may cause a notification to at least one user on the time-based consequences for such purchase [705].

FIG. 7 B is a user interface diagram that represents a scenario wherein the notification platform 109 causes a presentation of a detailed description of time-based information associated with purchase of the movie ticket for the 10:30 p.m. screening, according to one example embodiment. In one scenario, the notification platform 109 may provide the user with information on total duration of the movie [707], any known or anticipated interruptions (e.g. new movies trailers and advertisements [709], scheduled break [711]), actual movie starting time [713], actual movie ending time [715], and public transportation information [717]. In another scenario, a user may be given an option to choose their preferred mode of transportation [719]. The choice of transportation may be based, at least in part, on completion time for an event, schedule of public transportations, or a combination thereof.

FIG. 7 C is a user interface diagram that represents a scenario wherein the notification platform 109 cautions a user during his/her purchase transaction by presenting a warning message, according to one example embodiment. In one scenario, the warning message may include information on the completion time for a movie, the estimated time of arrival at his/her place of residence [721], or a combination thereof. Subsequently, a user may be given an option to proceed further with the purchase transaction by clicking confirm [723], or may withdraw the transaction by clicking cancel [725].

FIG. 7 D is a user interface diagram that represents a scenario wherein the notification platform 109 presents additional warning announcement to the at least one user during the purchase of a movie ticket, according to one example embodiment. In one scenario, a user may be informed on unavailability of public transportation after a certain time period (e.g. there is no public transportation available after the movie ends) [727]. In another scenario, the notification platform 109 may provide the at least one user with available alternative mode of transportation [727]. The user may be further informed on the cost involved in using the alternative mode of transportation [727]. Subsequently, a user may be given an option to proceed with the final step of the purchase transaction by clicking confirm [729], or may withdraw the transaction by clicking cancel [731]. In another scenario, if the original plan of a user was to take public transportation towards his residence and walk the last 15 minutes, this may not be possible after 1 a.m. As a result, the event of watching a late-night movie may prevent a user from attaining his/her target of walking certain distance every day. The notification platform 109 may inform a user of the consequences of a purchase to his/her fitness routine.

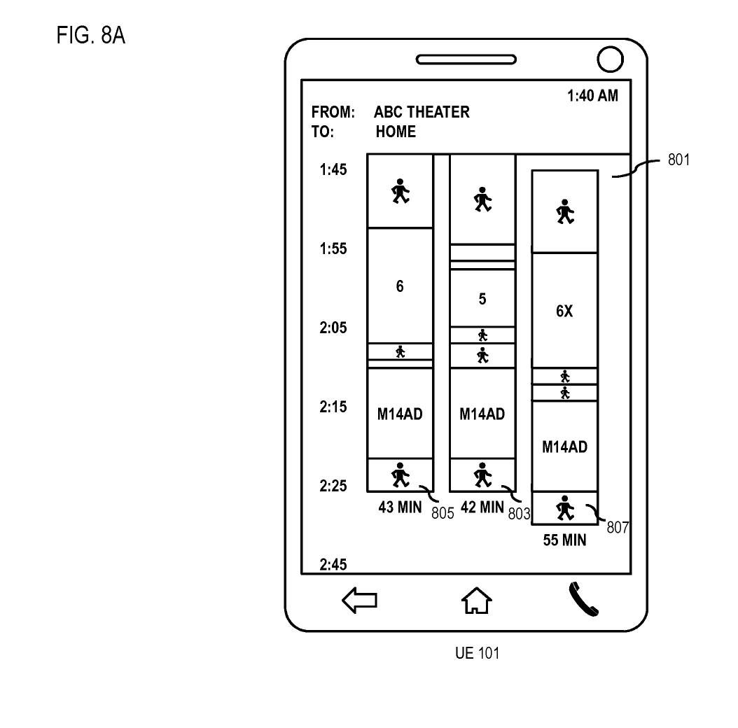

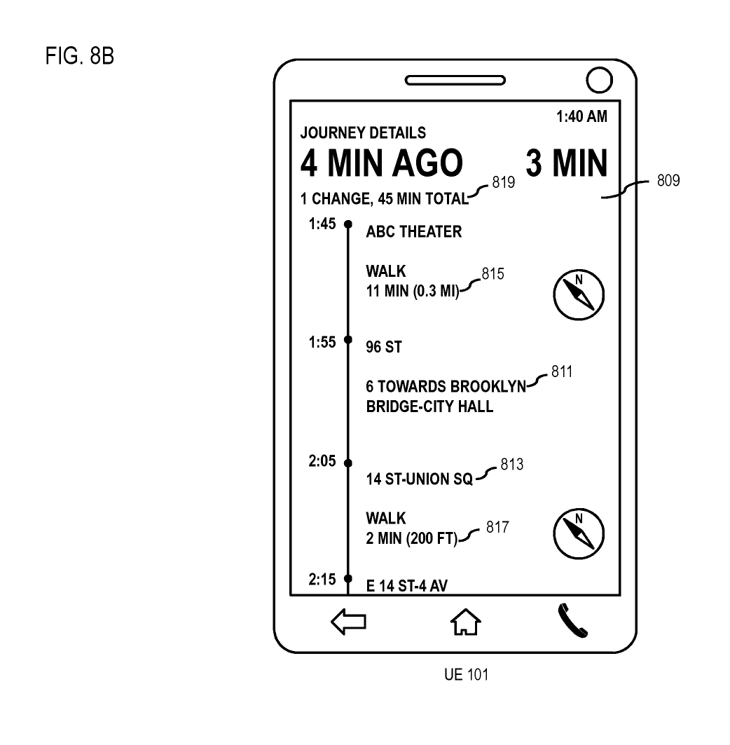

FIGS. 8 A-B are user interface diagrams utilized in the process of initiating a navigation application that allows multiple display of selected routes in a grid view and/or an information view, according to one example embodiment. In one scenario, a user activity of purchasing a ticket for an event may prompt the notification platform 109 to present the user with time-based information and mode of travel information to the at least one destination from his/her current location [801]. The user may be presented with the option of selecting the travel plan as per his/her convenience. If the user is in a hurry, he/she may opt for the second travel plan [803] as the user needs to walk for 42 minutes reach the destination. If the user is not in a rush then the user may opt for the first [805] or third [807] travel plan.

FIG. 8 B is a user interface diagram that represents a display of the information view based, at least in part, on user interaction. In one scenario, the information view provides a user with a timeline of his/her journey towards the ABC Theater [809]. The timeline may include routing information [811, 813], distance information [815, 817], total travel duration [819], or a combination thereof.

The processes described herein for notifying one or more users on time-based information associated with at least one event may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

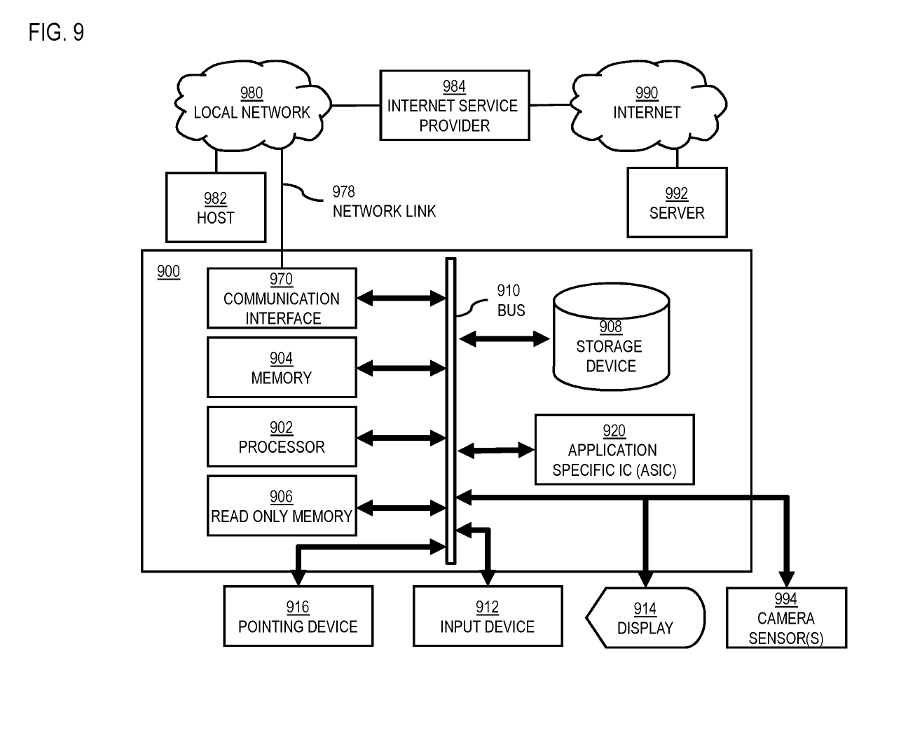

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to notify one or more users on time-based information associated with at least one event as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of notifying one or more users on time-based information associated with at least one event.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to notifying one or more users on time-based information associated with at least one event. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for notifying one or more users on time-based information associated with at least one event. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for notifying one or more users on time-based information associated with at least one event, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 107 for notifying one or more users on time-based information associated with at least one event to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to notify one or more users on time-based information associated with at least one event as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of notifying one or more users on time-based information associated with at least one event.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to notify one or more users on time-based information associated with at least one event. The memory 1005 also stores the data associated with or generated by the execution of the inventive steps.

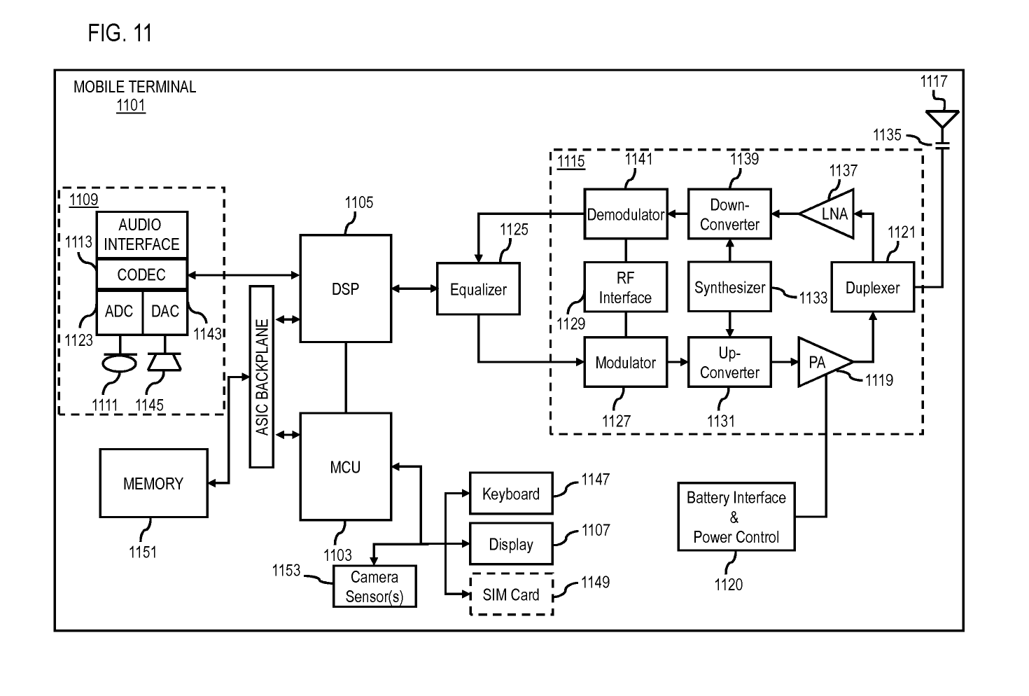

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of notifying one or more users on time-based information associated with at least one event. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of notifying one or more users on time-based information associated with at least one event. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to notify one or more users on time-based information associated with at least one event. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
causing, at least in part, a calculation of at least one estimated total time for engaging in at least one event requested by at least one user;
determining at least one potential time conflict with at least one other event; and
causing, at least in part, a presentation of at least one notification regarding the at least one potential conflict, the at least one estimated total time, or a combination thereof.

2. A method of claim 1, further comprising:
causing, at least in part, a generation of at least one request to confirm a selection of the at least one event by the at least one user,
wherein the at least one request to confirm is included in the at least one notification.

3. A method of claim 1, wherein the calculation of the at least one total time is based, at least in part, on travel time information associated with traveling to the at least one event, pre-event activity time information, post-event activity time information, intermission time information, interruption time associated, or a combination thereof.

4. A method of claim 3, further comprising:
causing, at least in part, a querying of at least one database of transport schedule information to determine the travel time information,
wherein the transport schedule information relates, at least in part, to one or more modes of public transport, one or more modes of private transport, or a combination thereof.

5. A method of claim 4, further comprising:
determining at least one unavailability of the one or more modes of public transport, the one or more modes of private transport, or a combination thereof based, at least in part, on the transport schedule information; and
causing, at least in part, a presentation of the at least one unavailability in the at least one notification.

6. A method of claim 1, further comprising:
processing and/or facilitating a processing of meta-data, contextual information, historical information, or a combination thereof associated with the at least one event, the at least one user, or combination thereof to calculate the at least one estimated total time.

7. A method of claim 1, further comprising:
causing, at least in part, a generation of routing information for traveling to or from the at least one event,
wherein the total estimated total time is further based, at least in part, on the routing information.

8. A method of claim 1, further comprising:
causing, at least in part, a calculation of at least one predicted pricing trend for engaging in the at least one event,
wherein the at least one notification further includes, at least in part, the at least one predicting pricing trend.

9. A method of claim 8, wherein the at least one notification includes, at least in part, one or more alerts indicating that the at least on pricing trend is increasing or decreasing.

10. A method of claim 1, further comprising:
causing, at least in part, a querying of at least one calendar database associated with the at least one user to determine the at least one other event.

11. An apparatus comprising:
at least one processor; and
at least one memory including computer program code for one or more programs,
the at least one memory and the computer program code configured to, with the at least one processor, cause the apparatus to perform at least the following,
cause, at least in part, a calculation of at least one estimated total time for engaging in at least one event requested by at least one user;
determine at least one potential time conflict with at least one other event; and
cause, at least in part, a presentation of at least one notification regarding the at least one potential conflict, the at least one estimated total time, or a combination thereof.

12. An apparatus of claim 11, wherein the apparatus is further caused to:
cause, at least in part, a generation of at least one request to confirm a selection of the at least one event by the at least one user,
wherein the at least one request to confirm is included in the at least one notification.

13. An apparatus of claim 11, wherein the calculation of the at least one total time is based, at least in part, on travel time information associated with traveling to the at least one event, pre-event activity time information, post-event activity time information, intermission time information, interruption time associated, or a combination thereof

14. An apparatus of claim 13, wherein the apparatus is further caused to:
cause, at least in part, a querying of at least one database of transport schedule information to determine the travel time information,
wherein the transport schedule information relates, at least in part, to one or more modes of public transport, one or more modes of private transport, or a combination thereof.

15. An apparatus of claim 14, wherein the apparatus is further caused to:
determine at least one unavailability of the one or more modes of public transport, the one or more modes of private transport, or a combination thereof based, at least in part, on the transport schedule information; and
cause, at least in part, a presentation of the at least one unavailability in the at least one notification.

16. An apparatus of claim 11, wherein the apparatus is further caused to:
process and/or facilitate a processing of meta-data, contextual information, historical information, or a combination thereof associated with the at least one event, the at least one user, or combination thereof to calculate the at least one estimated total time.

17. An apparatus of claim 11, wherein the apparatus is further caused to:
cause, at least in part, a generation of routing information for traveling to or from the at least one event,
wherein the total estimated total time is further based, at least in part, on the routing information.

18. A computer-readable storage medium carrying one or more sequences of one or more instructions which, when executed by one or more processors, cause an apparatus to at least perform the following steps:
cause, at least in part, a calculation of at least one estimated total time for engaging in at least one event requested by at least one user;
determine at least one potential time conflict with at least one other event; and
cause, at least in part, a presentation of at least one notification regarding the at least one potential conflict, the at least one estimated total time, or a combination thereof.

19. A computer-readable storage medium of claim 18, wherein the apparatus is further caused to:
cause, at least in part, a generation of at least one request to confirm a selection of the at least one event by the at least one user,
wherein the at least one request to confirm is included in the at least one notification.

20. A computer-readable storage medium of claim 18, wherein the calculation of the at least one total time is based, at least in part, on travel time information associated with traveling to the at least one event, pre-event activity time information, post-event activity time information, intermission time information, interruption time associated, or a combination thereof.

21.-48. (canceled)
